(19) United States
(12) Patent Application Publication
(10) Pub. No.: US 2006/0041909 A1
(43) Pub. Date: Feb. 23, 2006

(54) Information recording apparatus and method, and computer program product

(76) Inventors: Tomoharu Kirihara, Saitama (JP); Masaki Kurihara, Saitama (JP); Yoshitaka Yaeguchi, Saitama (JP); Takeo Miyazaki, Saitama (JP); Kenji Azuma, Saitama (JP)

Correspondence Address: YOUNG & THOMPSON, 745 SOUTH 23RD STREET, 2ND FLOOR, ARLINGTON, VA, 22202, US

(21) Appl. No.: 11/198,440

(22) Filed: Aug. 8, 2005

(30) Foreign Application Priority Data
Aug. 6, 2004 (JP) 2004-230184

(51) Int. Cl. H04N 5/445; H04N 7/173; G06F 13/00; G06F 3/00

(52) U.S. Cl. 725/58; 725/40; 725/89

(57) ABSTRACT

An information recording apparatus is provided with: a reserving device for specifying a channel, a recording start time point, and a recording end time point of a regular broadcast program which is regularly broadcasted (i.e. every week, every day, every month, or the like), to thereby reserve the regular broadcast program; an obtaining device for obtaining Electronic Program Guide (EPG) information which is distributed along with or aside from the regular broadcast program and which includes airtime zone information for indicating a channel, a broadcast start time point, and a broadcast end time point; a recording device capable of recording the regular broadcast program; and a controlling device for (i) controlling the recording device to record the regular broadcast program from the recording start time point, (ii) searching for the broadcast end time point of the regular broadcast program, from the EPG information, while the regular broadcast program is recorded, and (iii) controlling the recording device to record the regular broadcast program until the searched broadcast end time point

### BACKGROUND OF THE INVENTION

1. Field of the Invention

The present invention relates to an information recording apparatus and an information recording method, which can obtain Electric Program Guide (EPG) information for indicating the attribute information of a broadcast program and which can record the broadcast program or the like onto an information recording medium, such as a hard disk and a DVD, as well as a computer program product.

2. Description of the Related Art

In Japanese Patent Application Laid Open NO. 2003-46921, at first, textual information, such as a character string, which indicates title names and genre names (or type names) of broadcast programs which constitute EPG information is searched for a character string included in the title name of a broadcast program desired by a user who is a viewer of broadcast programs (hereinafter referred to as a “user”, as occasion demands). Then, as a result of the searching, recording is automatically performed when it comes to the airtime of the relevant broadcast program. It discloses a technology about a recording method capable of performing autonomous recording on the basis of such algorithm.

In some cases, however, as for a program broadcasted on a regular basis (i.e. every week, every day, every month, or the like) at predetermined time intervals (hereinafter referred to as a “regular broadcast program”), such as a drama broadcasted every Monday, the initial episode (i.e. the first episode) or the final episode may be broadcasted over a longer period of time than the normal period of broadcast time, as a special version or the like. Alternatively, before the start time of the initial episode (i.e. the first episode) or the final episode, a promotion and a summary or the like about the regular broadcast program may be broadcasted. In this case, in Japanese Patent Application Laid Open NO. 2003-46921, if the searching is performed by using the character string included in the title name of the regular broadcast program, there is a possibility that in addition to the accompanying and secondary broadcast programs other than the main body of the regular broadcast program, irrelevant broadcast programs are searched for and recorded. This results in less data capacity which can be used and incapability of recording the entire airtime of the desired regular broadcast program, which is a technical problem.

Moreover, in the EPG information, there are also possibilities of error in writing of the title name of the broadcast program, lack of the genre name, or the like. As described above, if the searching is performed on the basis of the title name and the genre name, there is a possibility that the desired program is not searched for nor recorded. On the contrary, in the searching by using the title name or the like, there is also a possibility that another program or other many programs unrelated to the desired program are searched for by mistake, which is a technical problem.

### SUMMARY OF THE INVENTION

It is therefore an object of the present invention to provide an information recording apparatus and an information recording method which can record a reserved regular broadcast program which is desired by a user, more accurately, as well as a computer program which makes a computer as the information recording apparatus.

(Information Recording Apparatus)

The above object of the present invention can be achieved by an information recording apparatus, provided with: a reserving device for specifying a channel, a recording start time point (i.e. a time to start a recording of a desired regular broadcast program), and a recording end time point (i.e. a time to terminate the recording of the desired regular broadcast program) of a regular broadcast program which is regularly broadcasted, to thereby reserve the regular broadcast program; an obtaining device for obtaining Electronic Program Guide (EPG) information which is distributed along with or aside from the reserved regular broadcast program and which includes airtime zone information for indicating a channel, a broadcast start time point, and a broadcast end time point of at least the reserved regular broadcast program; a recording device capable of recording the reserved regular broadcast program; and a controlling device for (i) controlling the recording device to record the reserved regular broadcast program from the recording start time point of the reserved regular broadcast program, (ii) searching for the airtime zone information for indicating the broadcast end time point of the reserved regular broadcast program, from the obtained EPG information, while the regular broadcast program is recorded by the recording device, and (iii) controlling the recording device to record the reserved regular broadcast program until the broadcast end time point shown by the searched airtime zone information.

According to the information recording apparatus of the present invention, at first, the regular broadcast program which is regularly broadcasted (i.e. every week, every day, every month, or the like), such as a drama broadcasted every Monday, and which is desired by a user is reserved by the reserving device. Then, under the control of the controlling device, the recording is started from the recording start time point of the reserved regular broadcast program, by the recording device. The EPG information which is distributed along with or aside from the reserved regular broadcast program and which includes the airtime zone information for indicating the channel, the broadcast start time point, and the broadcast end time point of the reserved regular broadcast program, is obtained by the obtaining device. Then, under the control of the controlling device, the information for indicating the newest broadcast end time point of the reserved regular broadcast program which is being recorded, is searched for from the obtained EPG information, on the basis of the information for indicating the channel, the broadcast start time point, and the broadcast end time point, for example. Then, under the control of the controlling device, the reserved regular broadcast program is recorded until the searched newest broadcast end time point, by the recording device.

If in place of the channel, the broadcast start time point, and the broadcast end time point, the textual information, such as a character string, which indicates title names and genre names (or type names) of broadcast programs (or regular broadcast programs), which constitute the EPG information, is searched for a character string included in the title name of the broadcast program desired by the user, there is a possibility that in addition to the accompanying and secondary broadcast programs, such as a promotion program and a summary, other than the main body of the regular broadcast program, irrelevant broadcast programs are searched for and recorded. Thus, the data capacity (or resource) of the information recording medium is wastefully used (or consumed). This results in less data capacity which can be used and incapability of recording the entire airtime of the desired regular broadcast program. Moreover, in the EPG information, there are also possibilities of error in writing of the title name of the broadcast program, lack of the genre name, or the like. As described above, if the searching is performed on the basis of the title name and the genre name, there is a possibility that the desired program is not searched for nor recorded.

On the contrary, according to the information recording apparatus of the present invention, the recording of the reserved regular broadcast program desired by the user is started from the reserved recording start time point. Then, the information for indicating the newest broadcast end time point of the reserved regular broadcast program which is being recorded, is searched for from the obtained EPG information, on the basis of the information for indicating the channel, the broadcast start time point, and the broadcast end time point, for example. The reserved regular broadcast program is recorded until the searched newest broadcast end time point. Therefore, it is possible to appropriately respond to the change in the broadcast end time point of the reserved regular broadcast program which is desired by the user, and stop the reserved recording of the regular broadcast program at the newest broadcast end time point. Thus, it is possible to prevent the recording of broadcast programs which are not desired by the user, and it is almost or completely possible to prevent the wasteful use (or consume) of the data capacity of the information recording medium.

In addition, according to the information recording apparatus of the present invention, the searching based on the title name and the genre name is not performed, in recording the reserved regular broadcast program. Thus, even if one regular broadcast program ends after coming up with the final episode and another regular broadcast program is broadcasted from next time, it is possible to continue following the EPG information, appropriately. Namely, even if the information for reservation, such as the title name, the channel, and the airtime zone, is not inputted again, the searching of the broadcast end time point from the EPG information and the recording until the broadcast end time point are performed, as described above, by which it is possible to appropriately follow the EPG information.

In one aspect of the information recording apparatus of the present invention, the controlling device controls the recording device to record the reserved regular broadcast program until the broadcast end time point shown by the searched airtime zone information if the broadcast end time point shown by the searched airtime zone information is different from the recording end time point of the reserved regular broadcast program, and controls the recording device to record the reserved regular broadcast program until the recording end time point if the broadcast end time point shown by the searched airtime zone information is equal to the recording end time point of the reserved regular broadcast program.

According to this aspect, it is possible to record the reserved regular broadcast program desired by the user, more efficiently.

In another aspect of the information recording apparatus of the present invention, the controlling device is further provided with a storing device for storing therein the recording start time point and the recording end time point of the reserved regular broadcast program, updates the recording end time point stored in the storing device to the broadcast end time point shown by the searched airtime zone information if the broadcast end time point shown by the searched airtime zone information is different from the recording end time point of the reserved regular broadcast program, and controls the recording device to record the reserved regular broadcast program until the stored recording end time point.

According to this aspect, it is possible to record the reserved regular broadcast program desired by the user, more certainly and more accurately, by using the storing device.

In another aspect of the information recording apparatus of the present invention, the reserving device calculates an expected record time length from the recording start time point to the recording end time point, the controlling device has a measuring device for measuring a first record time length of a first broadcast program recorded at first as the reserved regular broadcast program, and the controlling device (iv) further searches for information for indicating a second broadcast end time point, which is a broadcast end time point of a second broadcast program, broadcasted next to the first broadcast program, from the obtained EPG information if the measured first record time length is shorted than a predetermined ratio of the expected record time length, and (v) controls the recording device to record the second broadcast program until the second broadcast end time point, following the first broadcast program.

According to this aspect, if the first record time length of the first broadcast program recorded at first is shorter than the predetermined ratio (e.g. 65%) of the expected record time length which is between the recording start time point and the recording end time point, even the second broadcast program which is broadcasted next is recorded, in addition to the first broadcast program. Therefore, even in an unexpected case, such as the case where the reserved regular broadcast program desired by the user is broadcasted later than the normal airtime zone, it is possible to record the reserved regular broadcast program desired by the user, more accurately.

More specifically, in some cases, as for the program broadcasted on a regular basis (i.e. every week, every day, every month, or the like), such as a drama broadcasted every Monday, a promotion and a summary or the like about the regular broadcast program may be broadcasted before the start time of the initial episode (i.e. the first episode) or the final episode. In this case, the promotion and the summary or the like are separated from the main body of the regular broadcast program, and other broadcast end time point different from that of the main body of the regular broadcast program are shown in the EPG information. According to this aspect, however, in addition to the promotion and the summary or the like, the subsequently broadcasted main body of the regular broadcast program is also recorded.

In another aspect of the information recording apparatus of the present invention, the controlling device searches the obtained EPG information after a predetermined standby time elapses from the recording start time point of the reserved regular broadcast program.

According to this aspect, in an unexpected case, such as the case where the reserved regular broadcast program desired by the user is broadcasted later than the normal airtime zone, the searching of the broadcast end time point of the reserved regular broadcast program and the recording until the broadcast end time point are performed after the predetermined time elapses, such as 14 min, under the control of the controlling device.

Therefore, it is possible to record the reserved regular broadcast program desired by the user, more accurately.

More specifically, in some cases, as for the program broadcasted on a regular basis (i.e. every week, every day, every month, or the like), such as a drama broadcasted every Monday, a promotion and a summary or the like about the regular broadcast program may be broadcasted before the start time of the initial episode (i.e. the first episode) or the final episode. In this case, the promotion and the summary or the like are separated from the main body of the regular broadcast program, and other broadcast end time point different from that of the main body of the regular broadcast program are shown in the EPG information. According to this aspect, however, the searching of the end time point of the main body of the regular broadcast program is performed after the predetermined standby time elapses. Thus, with little or no influence of the other broadcast end time point of the promotion and the summary or the like, it is possible to record the regular broadcast program until the broadcast end time point of the main body thereof.

In another aspect of the information recording apparatus of the present invention, the obtaining device is provided with: a receiving device (e.g. a tuner) for receiving the EPG information; and an information recording medium (e.g. a hard disk drive (HDD) and a DVD onto which EPGDB (i.e. EPG database) is recorded) onto which the received EPG information is recorded, and the controlling device searches for information for indicating the broadcast end time point from the recorded EPG information.

According to this aspect, for example, the EPG information distributed on “6” channel of analog broadcasting at predetermined intervals (e.g. at intervals of 4.5 hours) is stored into a memory device of the information recording apparatus or into one portion of the recording area of a HDD and a DVD, as database information, for example.

Therefore, it is possible to search for the information for indicating the broadcast end time point by the controlling device, more quickly and accurately.

(Information Recording Method)

The above object of the present invention can be also achieved by an information recording method in an information recording apparatus provided with a recording device capable of recording a regular broadcast program which is regularly broadcasted, the information recording method provided with: a reserving process of specifying a channel, a recording start time point, and a recording end time point of the regular broadcast program, to thereby reserve the regular broadcast program; an obtaining process of obtaining EPG information which is distributed along with or aside from the reserved regular broadcast program and which includes airtime zone information for indicating a channel, a broadcast start time point, and a broadcast end time point of at least the reserved regular broadcast program; and a controlling process of (i) controlling the recording device to record the reserved regular broadcast program from the recording start time point of the reserved regular broadcast program, (ii) searching for the airtime zone information for indicating the broadcast end time point of the reserved regular broadcast program, from the obtained EPG information, while the regular broadcast program is recorded by the recording device, and (iii) controlling the recording device to record the reserved regular broadcast program until the broadcast end time point shown by the searched airtime zone information.

According to the information recording method of the present invention, it is possible to receive the same various benefits as those of the information recording apparatus of the present invention.

Incidentally, in response to the various aspects of the information recording apparatus of the present invention described above, the information recording method of the present invention can adopt various aspects.

(Computer Program)

The above object of the present invention can be also achieved by a computer program product in a computer-readable medium for tangibly embodying a program of instructions executable by a computer in the information recording apparatus of the present invention (including its various aspects) to make the computer function as at least one portion of the reserving device, the obtaining device, the recording device, and the controlling device.

According to the computer program product of the present invention, the information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the information recording apparatus described above.

Incidentally, in response to various aspects in the information recording apparatus of the present invention, the computer program product of the present invention can also adopt various aspects.

The nature, utility, and further features of this invention will be more clearly apparent from the following detailed description with reference to preferred embodiment of the invention when read in conjunction with the accompanying drawings briefly described below.

As explained above, according to the information recording apparatus of the present invention, it is provided with the reserving device, the obtaining device, the recording device, and the controlling device. According to the information recording method of the present invention, it is provided with the reserving process, the obtaining process, and the controlling process. Therefore, it is possible to appropriately respond to the change in the broadcast end time point of the reserved regular broadcast program which is desired by the user, and stop the reserved recording of the regular broadcast program at the newest broadcast end time point. Thus, it is possible to prevent the recording of broadcast programs which are not desired by the user, and it is almost or completely possible to prevent the wasteful use (or consume) of the data capacity of the information recording medium.

### BRIEF DESCRIPTION OF THE DRAWINGS

FIG. 1 is a logical block diagram conceptually showing the basic structure of an information recording/reproducing apparatus according to embodiments of an information recording apparatus of the present invention;

FIG. 2 is a flowchart showing a flow of a recording operation of recording a second episode of the information recording/reproducing apparatus according to the first embodiment of the information recording apparatus of the present invention;

FIG. 3 is a schematic diagram showing an airtime zone from the first episode to the final episode of a general broadcast program, which is regularly broadcasted, such as every Monday, and which is a record object of the information recording/reproducing apparatus according to the first embodiment of the information recording apparatus of the present invention;

FIG. 4 is a list showing various information set for the information recording/reproducing apparatus according to the first embodiment of the information recording apparatus of the present invention in order for a user to reserve and record the first broadcast;

FIG. 5 is a flowchart showing a flow of a recording operation of recording the final episode of the information recording/reproducing apparatus according to the first embodiment of the information recording apparatus of the present invention;

FIG. 6 is a block diagram showing the detailed structure of the information recording/reproducing apparatus according to the embodiments of the information recording apparatus of the present invention;

FIG. 7 is a flowchart showing a flow of a recording operation of recording the third episode of the information recording/reproducing apparatus according to the second embodiment of the information recording apparatus of the present invention; and

FIG. 8 is a flowchart showing a flow of a recording operation of recording the third episode of the information recording/reproducing apparatus according to the third embodiment of the information recording apparatus of the present invention.

### DETAILED DESCRIPTION OF THE PREFERRED EMBODIMENTS

Embodiments according to the information recording apparatus of the present invention will be hereinafter explained with reference to the drawings. Incidentally, in the embodiments, an information recording/reproducing apparatus, such as a DVD recorder with a Hard Disk Drive (i.e. HDD), will be explained, which is provided with a receiver for receiving, for example, terrestrial analog broadcasting or terrestrial digital broadcasting and which performs recording onto an information recording medium, such as the HDD.

(First Embodiment of Information Recording Apparatus)

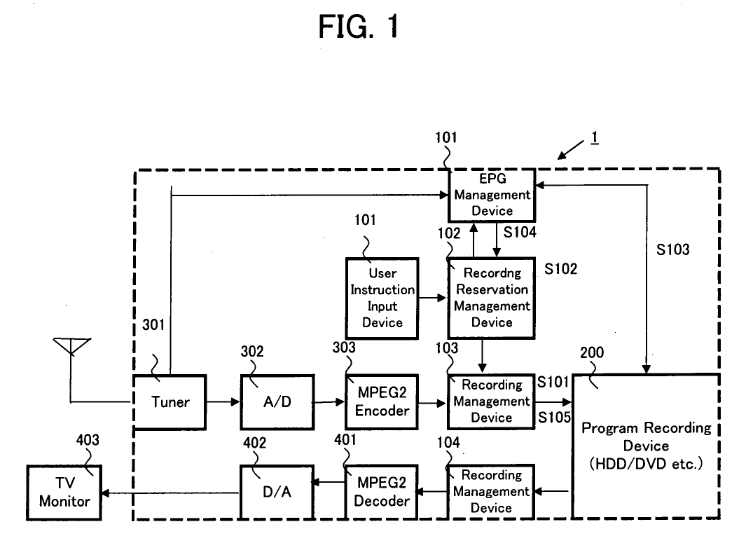

At first, with reference to FIG. 1 to FIG. 6, the first embodiment of the information recording apparatus of the present invention will be explained. Incidentally, in the explanation below, the information recording/reproducing apparatus, such as a DVD recorder with a HDD, which can not only record but also reproduce received data will be explained, as one specific example of the information recording apparatus of the present invention.

(1) Basic Structure

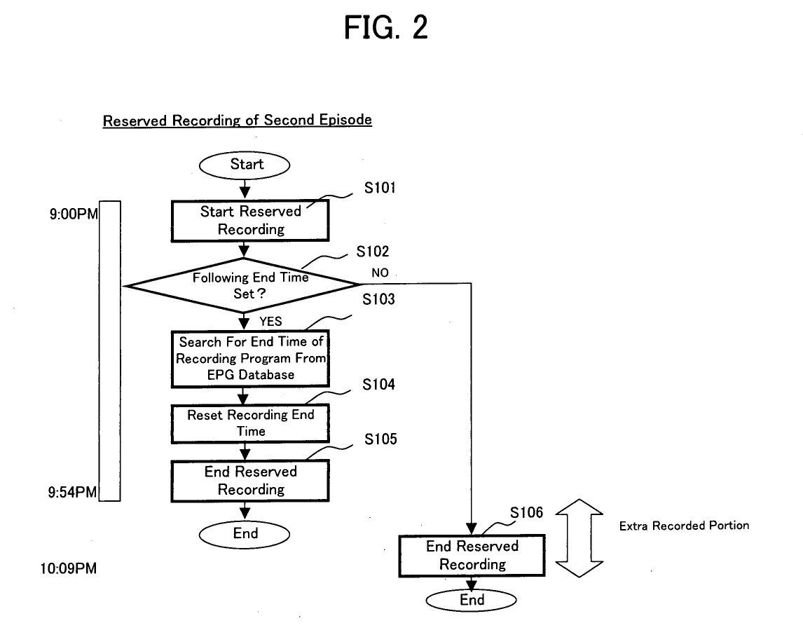

At first, with reference to FIG. 1, the basic structure of the information recording/reproducing apparatus in the first embodiment of the present invention will be explained. FIG. 1 conceptually shows the basic structure of the information recording/reproducing apparatus according to the embodiments. Incidentally, step numbers in FIG. 1 correspond to those in FIG. 2 described later.

As shown in FIG. 1, an information recording/reproducing apparatus 1 is provided with (i) the following four types of management devices, as constituent elements for performing various control and management, such as a Central Processing Unit (i.e. CPU). Namely, it is provided with: (i-1) a EPG management device 101 which constitutes one example of the “obtaining device” of the present invention; (i-2) a recording reservation management device 102 which constitutes one example of the “controlling device” of the present invention; (i-3) a recording management device 103 which constitutes one example of the “recording device” of the present invention; and (i-4) a reproduction management device 104.

Moreover, the information recording/reproducing apparatus 1 is provided with: (ii) a program recording device 200, such as a HDD and a DVD, which constitutes one example of the “information recording medium” and the “storing device” of the present invention; (iii) a tuner 301 which constitutes one specific example of the “receiving device” of the present invention, an Analog to Digital (A/D) converter 302, and a MPEG 2 encoder 303, as constitutional elements in a recording system; (iv) a MPEG 2 decoder 401, a Digital to Analog (D/A) converter 402, and a TV monitor 403, as constitutional elements in a reproduction system; and (v) a user instruction input device 500, as a user and an interface.

(Operation Principle)

Next, in addition to FIG. 2 to FIG. 5, with reference to FIG. 1, as occasion demands, the operation principle and the detailed structure of the information recording/reproducing apparatus in the first embodiment will be explained.

(2-1) Reserved Recording of Second Episode

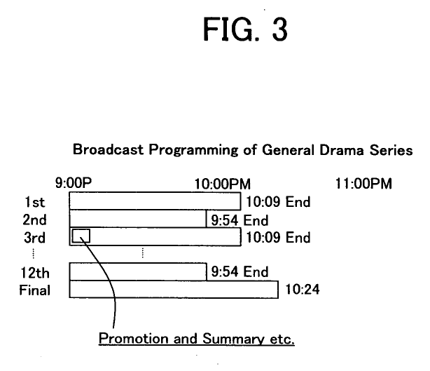

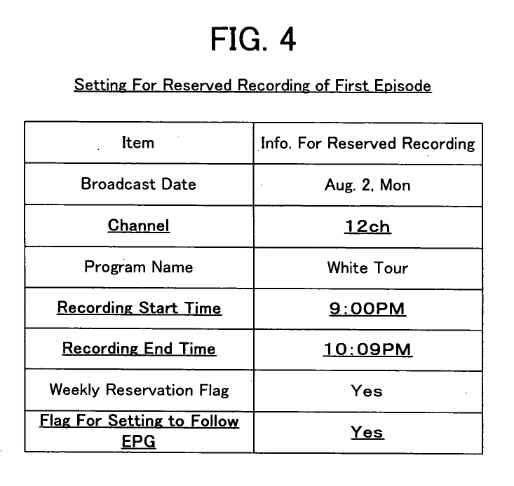

At first, in addition to FIG. 2, with reference to FIG. 3, FIG. 4, and FIG. 1, as occasion demands, an explanation is given to a flow of reserving and recording the second episode after the reserved recording of the first episode is succeeded, on the basis of the setting of the reserved recording by a user. FIG. 2 shows a flow of a recording operation of recording the second episode of the information recording/reproducing apparatus according to the first embodiment of the information recording apparatus of the present invention. FIG. 3 shows an airtime zone from the first episode to the final episode of a general broadcast program, which is regularly broadcasted, such as every Monday, and which is a record object of the information recording/reproducing apparatus according to the first embodiment of the information recording apparatus of the present invention. FIG. 4 shows various information set for the information recording/reproducing apparatus according to the first embodiment of the information recording apparatus of the present invention in order for a user to reserve and record the first broadcast.

At first, under the control of the recording reservation management device 102, if it comes to the recording start time point (e.g. 9:00 PM) of a broadcast program desired by a user, the recording of the second episode (e.g. on Aug. 9) into the program recording device 200 is started by the recording management device 103 (step S101).

In particular, as shown in FIG. 3 and FIG. 4, it is assumed herein that the user sets the reserved recording of the desired first episode (e.g. on Aug. 2) with the channel as “12ch”, the recording start time point as 9:00 PM, and the recording end time point as 10:09 PM, with reference to a TV program guide in a newspaper or the like. In addition, before the start of this recording, the EPG information received by the tuner 301 is recorded in the program recording device 200 in a form of database. More specifically, a distributor of an EPG, such as Gemstar-TV Guide International, Inc., distributes the EPG information by superimposing it onto the analog broadcast signal of “6” channel, five times a day (i.e. at time intervals of 4.5 hours). The information recording/reproducing apparatus 1 in the first embodiment is automatically started at a predetermined time point, and obtains the EPG information through the tuner or the like.

Then, under the control of the recording reservation management device 102, it is judged whether or not it is set to follow the EPG (steps S102). In particular, the setting of following the EPG may be performed by the user before the weekly reserved recording is ended (including during the recording). If it is set to follow the EPG, specifically, if a flag for indicating that it is set to follow the EPG is “Yes” (the step S102: Yes), the following searching is performed.

Namely, under the control of the EPG management device 101, the information about the broadcast end time point of the currently recording broadcast program (i.e. the second episode) is searched for from the EPG information recorded in the program recording device 200 in the form of database, on the basis of the airtime zone, such as the channel (specifically “12ch”) and the recording start time point (specifically 9:00 PM) (step S103). Incidentally, as shown in FIG. 3, the broadcast end time point of the second episode is changed to 9:54 PM in the EPG, so that the broadcast end time point to be searched for is this 9:54 PM.

Then, under the control of the EPG management device 101, the recording end time point (e.g. 10:09 PM) set for the reserved recording of the first episode described above is reset (updated in the setting) to the searched broadcast end time point (e.g. 9:54 PM) (step S104).

Then, under the control of the recording reservation management device 102, the recording of the second episode (e.g. on Aug. 9) into the program recording device 200 by the recording management device 103 is ended at the reset broadcast end time point (e.g. 9:54 PM) (step S105). In this manner, it is possible to appropriately respond to the change, such as the unexpected shortening of the broadcast end time point of the reserved regular broadcast program which is desired by the user, and stop the reserved recording of the regular broadcast program at the newest broadcast end time point. Thus, it is possible to prevent the recording of broadcast programs which are not desired by the user, and it is almost or completely possible to prevent the wasteful use (or consume) of the data capacity of the information recording medium.

On the other hand, if it is not set to follow the EPG, or if the information recording/reproducing apparatus 1 cannot follow the EPG (the step S102: No), the recording is performed until the recording end time point (e.g. 10:09 PM) set for the reserved recording of the first episode described above. Namely, if it is not set to follow the EPG, or if the EPG cannot be followed by the information recording/reproducing apparatus 1, it is impossible to respond to that the broadcast end time point of the second episode is different from that of the first episode, which causes the recording of excess information and a waste of the data amount of the program recording device 200.

(2-2) Reserved Recording of Final Episode

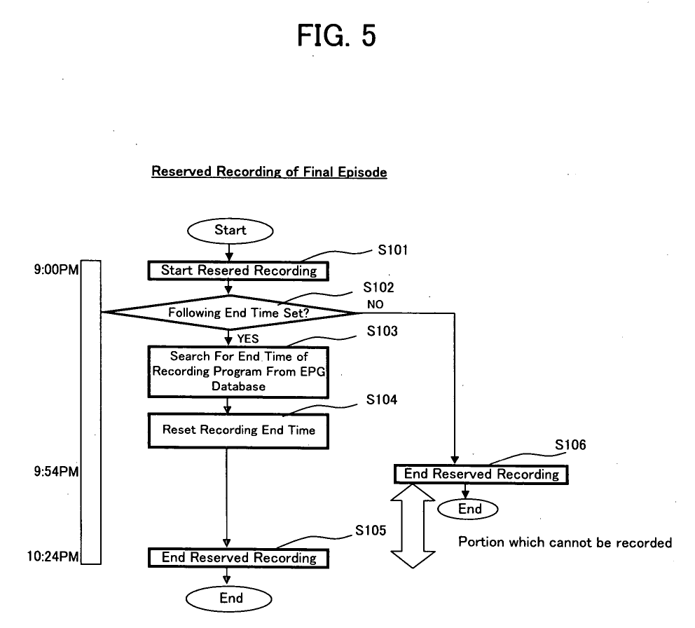

Next, in addition to FIG. 5, with reference to FIG. 3, as occasion demands, an explanation is given to a flow of reserving and recording the final episode after the reserved recording of the second episode to the 12th episode is succeeded, on the basis of the setting of the reserved recording by the user. FIG. 5 shows a flow of a recording operation of recording the final episode of the information recording/reproducing apparatus according to the first embodiment of the information recording apparatus of the present invention. Incidentally, the flow of the reserved recording is substantially the same as that shown in FIG. 2, so that the effect thereof will be focused in explanation.

In particular, as described above, it is judged whether or not it is set to follow the EPG (the step S102). If it is set to follow the EPG (the step S102: Yes), as described above, the information about the broadcast end time point of the currently recording broadcast program (i.e. the final episode) is searched for, on the basis of the airtime zone, such as the channel (specifically “12ch”) and the recording start time point (specifically 9:00 PM) in the step S103. Incidentally, as shown in FIG. 3, the broadcast end time point of the final episode is changed to 10:24 PM in the EPG, so that the broadcast end time point to be searched for is this 10:24 PM.

Then, under the control of the recording reservation management device 102, the recording of the final episode into the program recording device 200 by the recording management device 103 is ended at the broadcast end time point (e.g. 10:24 PM) reset in the step S104 (the step S105). In this manner, it is possible to appropriately respond to the change, such as the unexpected extension of the broadcast end time point of the reserved regular broadcast program which is desired by the user, and stop the reserved recording of the regular broadcast program at the newest broadcast end time point. Thus, it is possible to prevent the recording of broadcast programs which are not desired by the user, and it is almost or completely possible to prevent the wasteful use (or consume) of the data capacity of the information recording medium.

(3) Detailed Structure

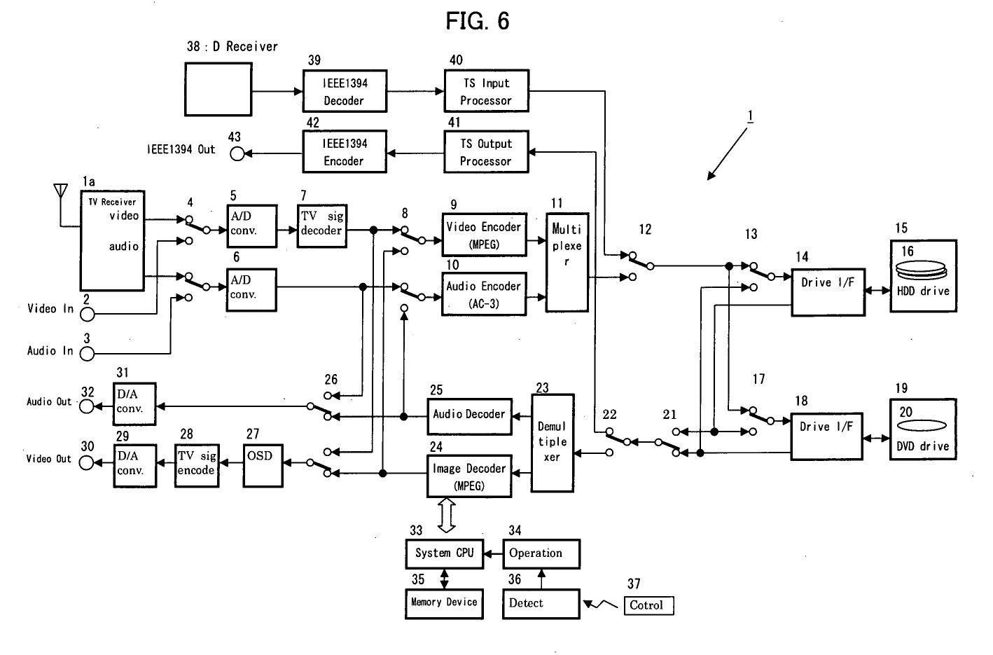

Next, with reference to FIG. 6, the detailed structure of the information recording/reproducing apparatus in the first embodiment. FIG. 6 is a block diagram showing the detailed structure of the information recording/reproducing apparatus according to the embodiments of the information recording apparatus of the present invention.

As shown in FIG. 6, the information recording/reproducing apparatus 1 is provided with: a TV receiver 1a; a video input 2; an audio input 3; an input switch 4; an A/D converter 5; an A/D converter 6; a TV signal decoder 7; an input switch 8; a video encoder (or an image encoder) 9; an audio encoder 10; a multiplexer 11; an input switch 12; a drive 1 input switch 13; a drive interface 14; a HDD drive 15; a HDD 16; a drive 2 input switch 17; a drive interface 18; a DVD drive 19; a DVD 20; a reproduction switch 21; an output switch 22; a demultiplexer 23; a video decoder (an image decoder) 24; an audio decoder 25; an output switch 26; a thumbnail OSD 27; a TV signal encoder 28; a D/A converter 29; a video output 30; a D/A converter 31; an audio output 32; a system CPU 33; an operation device 34; a memory device 35; a remote control photodetector 36; a remote controller 37; a digital receiver 38; an IEEE1394 decoder 39; a TS input processor 40; a TS output processor 41; an IEEE1394 encoder 42; and an IEEE1394 output 43.

(4) Detailed Operation

(4-1) If a Broadcast Program is Recorded

Next, with reference to FIG. 6, the detailed operation in the case where a broadcast program is recorded will be explained, along with the detailed structure.

(4-1a) Reception of Program Stream (PS)

The TV receiver 1a receives an RF signal, such as VHF and BS. The TV receiver 1a converts a signal wave received in synchronization with a selected received bandwidth, to an IF signal, demodulates it to a video signal for TV and an audio signal, and outputs it to the input switch 4.

The input switch 4 selectively changes the signal outputted from the TV receiver 1a and a signal from the video input 2 or the audio input 3. The input switch 4 outputs a video signal to the A/D converter 5 and an audio signal to the A/D converter 6.

The A/D converter 5 converts the analog signal for TV selected by the input switch 4 to a digital signal, and outputs it to the TV signal decoder 7.

The TV signal decoder 7 decodes the inputted digital signal for TV, converts it to a normal video signal in an NTSC method, and outputs it to the input switch 8.

The A/D converter 6 converts the analog audio signal selected by the input switch 4 to a digital audio signal, and outputs it to the input switch 8.

What are inputted to the input switch 8 are the video signal outputted from the TV signal decoder 7, and the audio signal outputted from the A/D converter 6. Moreover, if dubbing is performed from the HDD to the DVD or from the DVD to the HDD, what are inputted to the input switch 8 are a decoded video signal and a decoded audio signal which are outputted from the HDD drive 15 or the DVD drive 19. The input switch 8 selects any one of the inputted video signals and audio signals, on the basis of the control of the system CPU 33 described later. The input switch 8 outputs the selected video signal to the video encoder 9 and the selected audio signal to the audio encoder 10.

The video encoder 9 converts the video signal selected by the input switch 8 to video data in a MPEG format, and outputs it to the multiplexer 11.

The audio encoder 10 converts the audio signal selected by the input switch 8 to audio data in an AC-3 format, and outputs it to the multiplexer 11.

The multiplexer 11 generates a program stream (PS) on the basis of the inputted video data and audio data, and outputs it to the input switch 12.

What are inputted to the input switch 12 are the program stream outputted from the multiplexer 11 and a transport stream (TS) outputted from the TS input processor 40. The input switch 12 selects the inputted streams on the basis of the control of the system CPU 33, and outputs it to the drive 1 input switch 13 and the drive 2 input switch 17.

(4-1b) Reception of Transport Stream (TS)

The digital receiver 38 receives terrestrial digital broadcasting, for example.

The IEEE1394 decoder 39 converts a transport stream in an IEEE 1394 format which is inputted through the digital receiver 38 to a normal transport stream, and outputs it to the TS input processor 40.

The TS input processor 40 converts the inputted normal transport stream to transport stream data for HDD recording (hereinafter referred to as “TS data for HDD recording”, as occasion demands), and outputs it to the input switch 12.

The drive interface 14 compliant with a standard, such as ATAPI, is connected to the HDD drive 15. The drive 1 input switch 13 for changing the output from the input switch 12 is connected to the drive interface 14. The drive 1 input switch 13 changes an input source, by the control of the system CPU 33. Incidentally, the HDD drive 15 is constructed to record the stream (TS or PS) inputted through the input switch 12 onto the HDD 16.

(4-2) If Output from the HDD to the Exterior and the Display of a Thumbnail are Performed

In the information recording/reproducing apparatus 1, the TS output processor 41 converts inputted TS data for HDD recording to a normal transport stream, and outputs it to the IEEE1394 encoder 42. The IEEE1394 encoder 42 converts the inputted normal transport stream to a transport stream in the IEEE1394 format, and outputs it to the exterior through the IEEE1394 output 43. Moreover, it is possible to display a list of the recording content of each title, i.e. a thumbnail, on the thumbnail OSD 27, by using representative program information of each title recorded in the HDD drive 15. It is possible to convert it to Broadcast Markup Language (BML) for displaying a list of title of the transport stream, on the memory device 35 by the system CPU 33, and to output it from the TS output processor 41 through the IEEE1394 encoder 42 and the IEEE1394 output 43 to the exterior.

(4-3) If Recording onto the DVD and Reproduction from the DVD are Performed

The drive interface 18 compliant with the standard, such as ATAPI, is connected to the DVD drive 19. The drive 2 input switch 17 for changing the output from the HDD drive 15 or the output from the input switch 12 is connected to the drive interface 18. The drive 2 input switch 17 changes the input and the output, by the control of the system CPU 33, as in the drive 1 input switch 13. Incidentally, the DVD drive 19 is constructed to read the pre-recorded stream and output it to the reproduction switch 21 through the drive interface 18, as well as recording the stream inputted through the input switch 12 onto the DVD 20, as in the HDD drive 15.

The reproduction switch 21 selects either the stream outputted through the drive interface 14 from the HDD drive 15 or the stream outputted through the drive interface 17 from the DVD drive 19, on the basis of the system CPU 33, and outputs it to the output switch 22.

The output switch 22 selectively changes the stream inputted from the reproduction switch 21, on the basis of the system CPU 33. The output switch 22 outputs the program stream to the demultiplexer 23 and the transport stream to the TS output processor 41 described later.

The demultiplexer 23 separates video data having the MPEG format and audio data having an AXC-3 format (or an AC-3 format) from the program stream selected by the output switch 22. The demultiplexer 23 outputs the separated video data and audio data to the image decoder 24 and the audio decoder 25, respectively.

The image decoder 24 decodes the inputted video data in the MPEG format to a video signal, and outputs the decoded digital signal to the output switch 26.

The audio decoder 25 decodes the inputted video data in the AC-3 format to an audio signal, and outputs the decoded digital audio signal to the output switch 26.

What are inputted to the output switch 26 are the digital video signal outputted from the TV signal decoder 7, the digital audio signal outputted from the A/D converter 6, the decoded digital image signal decoded by the image decoder 24, and the digital audio signal decoded by the audio decoder 25. The output switch 26 changes the inputted video signals and audio signals, on the basis of the control of the system CPU 33. The output switch 26 outputs the video signal to the thumbnail OSD 27 and the audio signal to the D/A converter 31.

The thumbnail OSD 27 superimposes necessary textural information or the like onto the inputted video signal, and outputs it to the TV signal encoder 28.

The TV signal encoder 28 converts the inputted video signal to a video format for TV, in order to display it on an exterior monitor, and outputs it to the D/A converter 29.

The D/A converter 29 converts the inputted digital video signal for TV to an analog signal, and outputs it to the exterior through the video output 30.

The D/A converter 31 converts the inputted digital audio signal to an analog signal, and outputs it to the exterior through the audio output 32.

The system CPU 33 includes various input/output ports, such as a key input port and a display device output port, and controls all the general functions for respective processing, such as the reproduction and recording of the HDD 16 and the reproduction and recording of the DVD 20. Incidentally, the system CPU 33 reads a control program stored in the memory device 35, to thereby perform each processing, in the reproduction and recording of the HDD 16 and the reproduction and recording of the DVD 20. Then, the system CPU 33 temporarily holds the data which is being processed, in the memory device 35.

The operation device 34 is provided with many keys, such as various confirmation buttons, a numeric keypad, and crosshair cursor keys. The operation device 34 outputs a predetermined signal (i) by following a key operation, or (ii) based on outputted signal from the remote control photodetector 36.

The remote control photodetector 36 receives a light beam, such as infrared rays, emitted from the remote controller 37, and converts it to the predetermined signal, to thereby output it to the operation device 34.

The remote controller 37 is provided with many keys, such as various confirmation buttons, a numeric keypad, and crosshair cursor keys, as in the operation device 34.

(Second Embodiment of Information Recording/Reproducing Apparatus)

(1) Reserved Recording of Third Episode

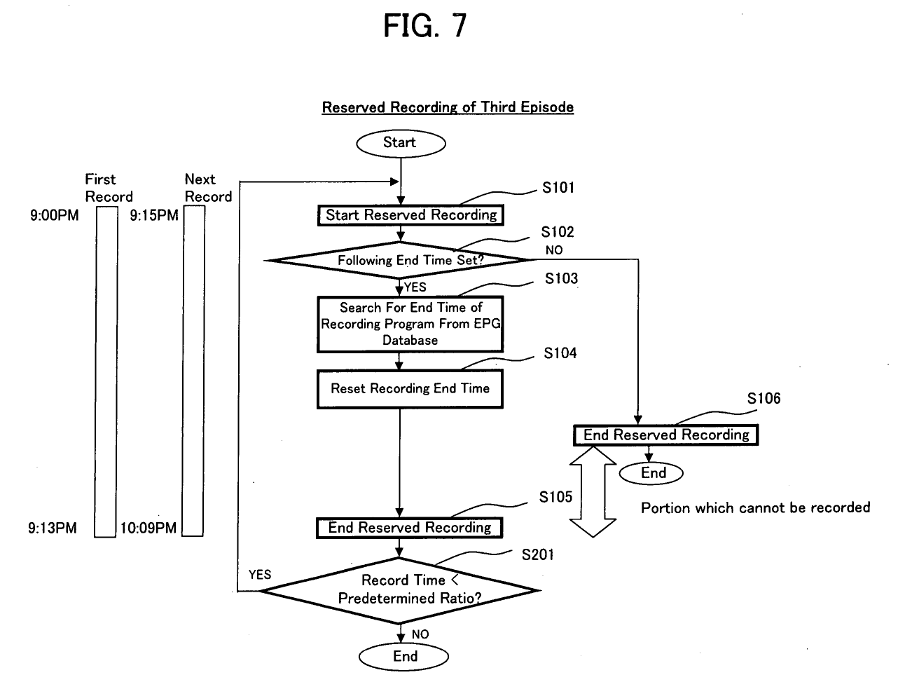

Next, in addition to FIG. 7, with reference to FIG. 3, as occasion demands, the operation principle and the detailed structure of the information recording/reproducing apparatus according to the second embodiment of the information recording apparatus of the present invention. FIG. 7 shows a flow of a recording operation of recording the third episode of the information recording/reproducing apparatus according to the second embodiment. Incidentally, in FIG. 7, the same steps as those in FIG. 2 and FIG. 5 carry the same step numbers, and the explanation thereof will be omitted.

The structure and the operation principle of the information recording/reproducing apparatus in the second embodiment are substantially the same as those in the first embodiment.

In particular, according to the information recording/reproducing apparatus in the second embodiment, even in an unexpected case, such as the case where a promotion and a summary about the third episode or the like are broadcasted before the broadcast start time point of the main body of the third episode, for example, as shown in FIG. 3, it is possible to record the reserved regular broadcast program desired by the user, more accurately.

More specifically, in a step S201 of FIG. 7, an expected record time length and an actual record time length (e.g. 13 min) are compared, with respect to the broadcast program recorded at first, under the control of the recording reservation management device 102. As a result of the comparison, if the actual record time length (e.g. 15 min) is shorter than a predetermined ratio (e.g. 65%=35 min) of the expected record time length (e.g. 54 min) (the step S201: Yes), it is judged that the promotion and the summary or the like are broadcasted aside from the desired broadcast program, and the main body of the third episode which is subsequently broadcasted next to the promotion and the summary or the like is recorded in addition to the broadcast program recorded at first (the step S101).

(Third Embodiment of Information Recording/Reproducing Apparatus)

(1) Reserved Recording of Third Episode

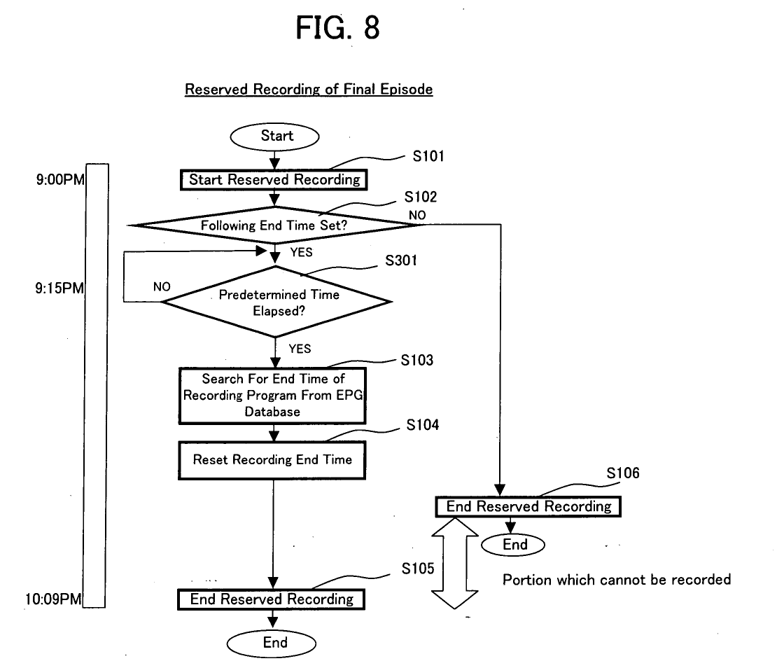

Next, in addition to FIG. 8, with reference to FIG. 3, as occasion demands, the operation principle and the detailed structure of the information recording/reproducing apparatus according to the third embodiment of the information recording apparatus of the present invention. FIG. 8 shows a flow of a recording operation of recording the third episode of the information recording/reproducing apparatus according to the third embodiment. Incidentally, in FIG. 8, the same steps as those in FIG. 2 and FIG. 5 carry the same step numbers, and the explanation thereof will be omitted.

The structure and the operation principle of the information recording/reproducing apparatus in the third embodiment are substantially the same as those in the first embodiment.

In particular, according to the information recording/reproducing apparatus in the third embodiment, even in an unexpected case, such as the case where a promotion and a summary about the third episode or the like are broadcasted before the broadcast start time point of the main body of the third episode, for example, as shown in FIG. 3, it is possible to record the reserved regular broadcast program desired by the user, more accurately.

More specifically, in a step S301 of FIG. 8, it is judged whether or not a predetermined time elapses, such as 14 min, for example, after the start of the reserved recording, under the control of the EPG management device 101. If the predetermined time elapses (the step S301: Yes), the searching in the step S103 is performed. On the other hand, as a result of the judgment in the step S301, if the predetermined time does not elapse (the step S301: No), the judgment is performed again.

As described above, according to the information recording/reproducing apparatus in the third embodiment, the searching and updating of the broadcast end time point of the main body of the third episode are performed, after the predetermined time elapses, under the control of the EPG management device 101. Thus, with little or no influence of the other broadcast end time point of the promotion and the summary or the like of the third episode, it is possible to record the third episode until the broadcast end time point of the main body thereof.

In the above-mentioned embodiments, the terrestrial analog broadcasting or the terrestrial digital broadcasting are explained as the carrier wave of a broadcast program. The present invention, however, can be applied to all the broadcasting formats of broadcast programs or the like distributed through Broadcasting Satellite (BS), Communication Satellite (CS), the Internet, and the like.

Moreover, in the above-mentioned embodiments, the DVD recorder (or player) with the HDD is explained as one example of the information recording apparatus. The present invention, however, is not limited to the recorder (or player) of a magnetic disk and an optical disc, and can be applied to other various recording media and recorders (or players) thereof.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-230184 filed on Aug. 6, 2004 including the specification, claims, drawings and summary is incorporated herein by reference in its entirety.

What is claimed is:

1. An information recording apparatus, comprising:
a reserving device for specifying a channel, a recording start time point, and a recording end time point of a regular broadcast program which is regularly broadcasted, to thereby reserve the regular broadcast program;
an obtaining device for obtaining Electronic Program Guide (EPG) information which is distributed along with or aside from the reserved regular broadcast program and which includes airtime zone information for indicating a channel, a broadcast start time point, and a broadcast end time point of at least the reserved regular broadcast program;
a recording device capable of recording the reserved regular broadcast program; and
a controlling device for (i) controlling said recording device to record the reserved regular broadcast program from the recording start time point of the reserved regular broadcast program, (ii) searching for the airtime zone information for indicating the broadcast end time point of the reserved regular broadcast program, from the obtained EPG information, while the regular broadcast program is recorded by said recording device, and (iii) controlling said recording device to record the reserved regular broadcast program until the broadcast end time point shown by the searched airtime zone information.

2. The information recording apparatus according to claim 1, wherein
said controlling device controls said recording device to record the reserved regular broadcast program until the broadcast end time point shown by the searched airtime zone information if the broadcast end time point shown by the searched airtime zone information is different from the recording end time point of the reserved regular broadcast program, and
controls said recording device to record the reserved regular broadcast program until the recording end time point if the broadcast end time point shown by the searched airtime zone information is equal to the recording end time point of the reserved regular broadcast program.

3. The information recording apparatus according to claim 1, wherein said controlling device
further comprises a storing device for storing therein the recording start time point and the recording end time point of the reserved regular broadcast program,
updates the recording end time point stored in said storing device to the broadcast end time point shown by the searched airtime zone information if the broadcast end time point shown by the searched airtime zone information is different from the recording end time point of the reserved regular broadcast program, and
controls said recording device to record the reserved regular broadcast program until the stored recording end time point.

4. The information recording apparatus according to claim 1, wherein
said reserving device calculates an expected record time length from the recording start time point to the recording end time point,
said controlling device has a measuring device for measuring a first record time length of a first broadcast program recorded at first as the reserved regular broadcast program, and
said controlling device (iv) further searches for information for indicating a second broadcast end time point, which is a broadcast end time point of a second broadcast program, broadcasted next to the first broadcast program, from the obtained EPG information if the measured first record time length is shorted than a predetermined ratio of the expected record time length, and (v) controls said recording device to record the second broadcast program until the second broadcast end time point, following the first broadcast program.

5. The information recording apparatus according to claim 1, wherein said controlling device searches the obtained EPG information after a predetermined standby time elapses from the recording start time point of the reserved regular broadcast program.

6. The information recording apparatus according to claim 1, wherein said obtaining device comprises:
a receiving device for receiving the EPG information; and
an information recording medium onto which the received EPG information is recorded, and
said controlling device searches for information for indicating the broadcast end time point from the recorded EPG information.

7. An information recording method in an information recording apparatus comprising a recording device capable of recording a regular broadcast program which is regularly broadcasted,
said information recording method comprising:
a reserving process of specifying a channel, a recording start time point, and a recording end time point of the regular broadcast program, to thereby reserve the regular broadcast program;
an obtaining process of obtaining EPG information which is distributed along with or aside from the reserved regular broadcast program and which includes airtime zone information for indicating a channel, a broadcast start time point, and a broadcast end time point of at least the reserved regular broadcast program; and
a controlling process of (i) controlling said recording device to record the reserved regular broadcast program from the recording start time point of the reserved regular broadcast program, (ii) searching for the airtime zone information for indicating the broadcast end time point of the reserved regular broadcast program, from the obtained EPG information, while the regular broadcast program is recorded by said recording device, and (iii) controlling said recording device to record the reserved regular broadcast program until the broadcast end time point shown by the searched airtime zone information.

8. A computer program product in a computer-readable medium for tangibly embodying a program of instructions executable by a computer to make the computer function as at least one portion of a reserving device, an obtaining device, a recording device, and a controlling device,
the computer being provided in an information recording apparatus, comprising:
said reserving device for specifying a channel, a recording start time point, and a recording end time point of a regular broadcast program which is regularly broadcasted, to thereby reserve the regular broadcast program;
said obtaining device for obtaining Electronic Program Guide (EPG) information which is distributed along with or aside from the reserved regular broadcast program and which includes airtime zone information for indicating a channel, a broadcast start time point, and a broadcast end time point of at least the reserved regular broadcast program;
said recording device capable of recording the reserved regular broadcast program; and
said controlling device for (i) controlling said recording device to record the reserved regular broadcast program from the recording start time point of the reserved regular broadcast program, (ii) searching for the airtime zone information for indicating the broadcast end time point of the reserved regular broadcast program, from the obtained EPG information, while the regular broadcast program is recorded by said recording device, and (iii) controlling said recording device to record the reserved regular broadcast program until the broadcast end time point shown by the searched airtime zone information.
